(19) United States
(12) Patent Application Publication
(10) Pub. No.: US 2007/0023495 A1
(43) Pub. Date: Feb. 1, 2007

(54) Method for controlling a multimodal terminal, processing platform and multimodal terminal

(76) Inventors: Jean-Marc Guillet, Thorigne Fouillard (FR); Valérie Ledunois, Laille (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/571,231

(22) PCT Filed: Aug. 27, 2004
(86) PCT No.: PCT/FR04/02208

§ 371 Date: Mar. 6, 2006

(30) Foreign Application Priority Data
Sep. 5, 2003 (FR) 0310541

(51) Int. Cl. G06F 17/00

(52) U.S. Cl. 235/375

(57) ABSTRACT

According to the invention, the method of controlling a multimode terminal (T) is characterized in that a sensor (CL, CS, CM) in the terminal (T) measures an environmental characteristic (L, S, M) thereof, a message (M1) is sent to a remote processing platform (P) containing the measured environmental characteristic (MES, L, S, M) and an indication (IDMA) of the information presentation mode that is currently active on the terminal (T), the indication (IDMA) is analyzed in accordance with a prescribed processing rule in the processing platform (P) to determine if it corresponds to a prescribed presentation mode indication (IDMR), and, if so, the measured environmental characteristic (MES, L, S, M) is analyzed to determine if it conforms to a prescribed condition (C1, C2, C3, C4, C5) in order, if so, to trigger automatically sending from the processing platform (P) to the terminal (T) of an instruction (IA) for activating therein a prescribed mode of presentation of information to the user that is not the currently active information presentation mode.

The invention relates to a method of controlling a terminal having a plurality of modes for presenting information to the user, the invention also relates to a processing platform and to a terminal for implementing the method.

The information presentation modes, for example graphics and voice presentation modes, can be activated or deactivated on the terminal and they are perceived through different senses of the user. A terminal having a plurality of modes for presenting information to the user is referred to as a multimode terminal.

One field of application of the invention is to multimode services of telecommunications terminals, such as mobile telephones, for example on-line services.

In the prior art, these services are implemented by interactive voice or graphics servers, for example.

At present these services are not user-friendly in that the user usually has no control over how the information linked to them is going to be presented.

The invention aims to control the terminal in a way that is better adapted to the needs of the terminal user.

To this end, a first aspect of the invention consists in a method of controlling a terminal having a plurality of modes of presenting information to a user that can be activated or deactivated on the terminal and perceived by a respective plurality of different senses of the user, characterized in that:

a sensor in the terminal measures an environmental characteristic thereof;

a message is sent to a remote processing platform containing the measured environmental characteristic and an indication of the information presentation mode currently active on the terminal, that is one of the indications of the presentation modes available therein;

the indication present in the message of the information presentation mode that is currently active is analyzed in accordance with a prescribed processing rule in the processing platform to determine if it corresponds to a presentation mode indication that is one of the indications of the presentation modes available on the terminal and is prescribed by that processing rule, and

if so, the measured value of the environmental characteristic is analyzed to determine if it conforms to a prescribed condition of said processing rule in order, if so:

to trigger automatically sending from the processing platform to the terminal of an instruction for activating therein a mode of presentation of information to the user selected from those available, prescribed in said processing rule, and other than the currently active information presentation mode corresponding to the indication present in the message;

reception in the terminal of the activation instruction causing the activation therein of said other prescribed information presentation mode specified in the activation instruction.

By means of the invention, the environment of the terminal user is taken into account when presenting information on the terminal to the user. For the user, this facilitates the use of the services. The modes of presentation of the information on the terminal are managed automatically to adapt to its environment. This improves the quality of the services provided, and in particular their continuity, by avoiding the problem of the user no longer being able to take note of the information that is being presented on the terminal if certain conditions occur in the environment; compare this to the prior art, in which information presented to the user on the terminal is “noisy” or masked by these environmental conditions, so that the user is no longer able to take note of the information, although the service provider is unaware of this.

According to other features of the invention:

in accordance with a first processing rule of the processing platform, the prescribed presentation mode indication corresponds to one of the graphic presentation modes on the terminal, which includes an environmental characteristic sensor in the form of an ambient light level sensor, the prescribed condition corresponds to the fact that the measured value of the ambient light level is less than a prescribed ambient light value, and said other prescribed information presentation mode specified in the activation instruction corresponds to one of the vocal presentation modes available on the terminal;

in accordance with a second processing rule of the processing platform, the prescribed presentation mode indication corresponds to one of the vocal presentation modes available on the terminal, which includes an environmental characteristic sensor in the form of an ambient sound level sensor, the prescribed condition corresponds to the fact that the measured value of the ambient sound level is greater than a prescribed ambient sound level value, and said other prescribed information presentation mode specified in the activation instruction corresponds to one of the graphic presentation modes available on the terminal;

in accordance with a third processing rule of the processing platform, the prescribed presentation mode indication corresponds to one of the graphic presentation modes available on the terminal, which includes an environmental characteristic sensor in the form of a sensor of motion or of stopping of motion of the terminal relative to its environment, the prescribed condition corresponds to the fact that the measured value of the motion level is greater than a prescribed motion level value, and said other prescribed information presentation mode specified in the activation instruction corresponds to one of the vocal presentation modes available on the terminal;

in accordance with a fourth processing rule of the processing platform, the prescribed presentation mode indication corresponds to one of the graphic presentation modes available on the terminal, which includes environmental characteristic sensors in the form of a sensor of motion or of stopping of motion of the terminal relative to its environment and an ambient sound level sensor, the prescribed condition corresponds to the fact that the measured value of the motion level is greater than a prescribed motion level value and the fact that the measured value of the ambient sound level is less than a prescribed ambient sound level value, and said other prescribed information presentation mode specified in the activation instruction corresponds to one of the vocal presentation modes available on the terminal;

in accordance with a fifth processing rule of the processing platform, the prescribed presentation mode indication corresponds to one of the vocal presentation modes available on the terminal, which includes an environmental characteristic sensors in the form of a sensor of motion or of stopping of motion of the terminal relative to its environment and an ambient sound level sensor, the prescribed condition corresponds to the fact that the measured value of the motion level is greater than a prescribed motion level value and the fact that the measured value of the ambient sound level is greater than a prescribed ambient sound level value, and said other prescribed information presentation mode specified in the activation instruction corresponds to one of the graphic presentation modes available on the terminal;

each time actuation of a control of the terminal by the user is detected in the terminal an environmental characteristic thereof is a measured in said terminal, followed by sending the processing platform said message including the measured environmental characteristic and the indication of the information presentation mode currently active on the terminal;

said message including the measured environmental characteristic and an indication of the information presentation mode currently active on the terminal is sent to the platform with a request for information, the platform being adapted to send the information to the terminal;

said processing rule is associated with the terminal of the user and is modifiable by the user from the terminal via a communication interface between the processing platform and the terminal;

said processing rule is present by default in the processing platform for all the user terminals;

said processing rule is created or modified beforehand by input on a machine of the user adapted to communicate with the processing platform;

the terminal includes means for entry of data by the user, the processing platform includes a memory for storing data entered on the terminal, and, after activation on the terminal of said other prescribed information presentation mode specified in the activation instruction, the data of the terminal reverts to that stored before said activation;

the information presentation modes available on the terminal include display on a screen of the terminal and reproduction of sound via a loudspeaker of the terminal;

the message and the activation instruction are sent over a telecommunication network;

the telecommunication network is of one of the following types: 802.11, Bluetooth, Wi-Fi, RTC, GSM Data, UMTS.

A second aspect of the invention consists in a processing platform for implementing the above control method, characterized in that it includes:

means for receiving a message including said measured environmental characteristic and said indication of the information presentation mode currently active on the terminal that is one of the indications of the presentation modes available thereon;

means for analyzing in the processing platform and in accordance with a prescribed processing rule the indication of the information presentation mode that is currently active present in the message to determine if it corresponds to a presentation mode indication prescribed by that processing rule that is one of the indications of the presentation modes available on the terminal, and, if so, to determine if the measured value of the environmental characteristic present in the message conforms to a prescribed condition of said processing rule to supply a positive signal in the event of an affirmative response; and

means for automatically sending from the processing platform to the terminal, if the analysis means supply a positive signal, an instruction for activation thereon of a prescribed mode of presentation of information to the user that is one of those available thereon and not the information presentation mode that is currently active corresponding to the indication present in the message.

According to one feature of the processing platform, it includes means for supplying information and means for sending the information to the terminal.

A third aspect of the invention consists in a terminal for implementing the above control method having a plurality of modes of presenting information to the user which can be activated or deactivated on the terminal and are perceived by a respective plurality of different senses of the user, characterized in that it includes:

a sensor for measuring an environmental characteristic of the terminal;

means for sending to the remote processing platform a message including the measured environmental characteristic and an indication of the information presentation mode that is currently active on the terminal and is one of the indications of the presentation modes available thereon; and

means for receiving an activation instruction causing activation in the terminal of an information presentation mode that is specified in the activation instruction and is one of those available on the terminal.

According to one feature the terminal includes one or more of the following environmental characteristic sensor: an ambient light level sensor, an ambient sound level sensor, a sensor of motion or of stopping of motion of the terminal relative to the environment, a sensor of the presence of persons, an obstacle sensor.

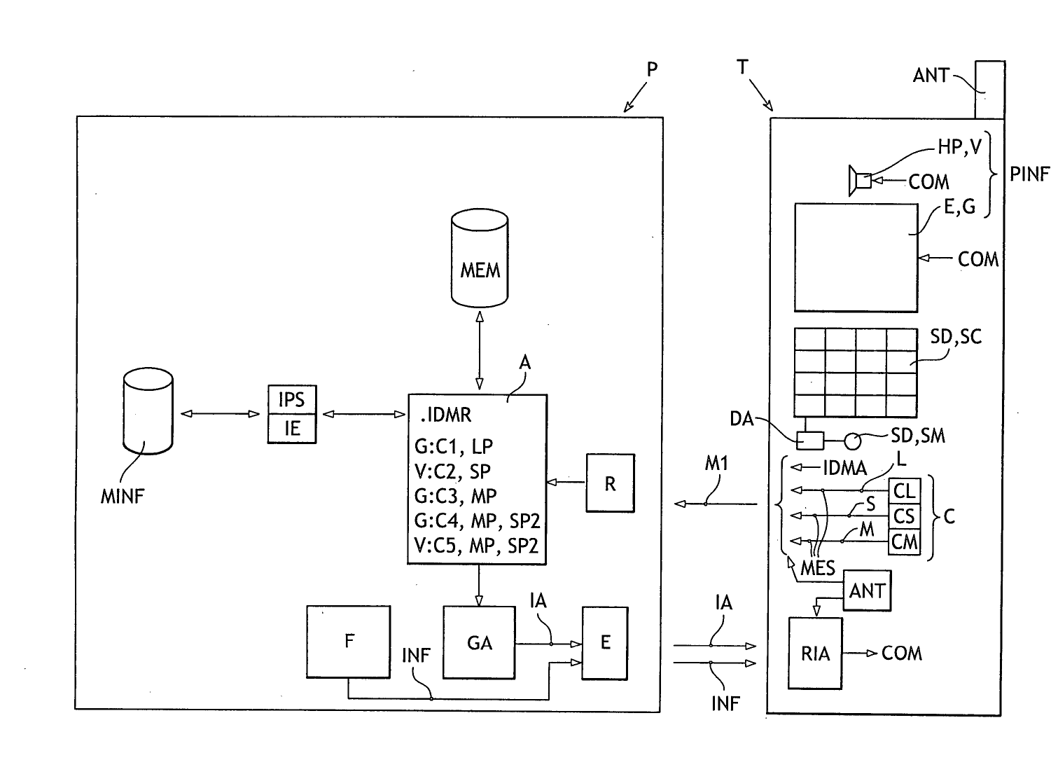

The invention will be better understood after reading the following description, which is given by way of non-limiting example only and with reference to the appended drawing, in which FIG. 1 is a diagram representing a terminal and a processing platform for implementing the control method of the invention.

In the FIGURE, a multimode terminal T of a user offers a plurality of modes for corresponding information presentation means PINF to use to present information to the user, for example a vocal presentation mode V and a graphic presentation mode G. The information may have any content and must be supplied to the user on the terminal T in the context of the provision of a service by a platform P of a service provider (see below) and which may be a voice or a graphic service (V, G) in the above example. The terminal T also includes a screen E for displaying information, for example, and a loudspeaker HP for reproducing information. Each presentation mode can be activated or deactivated independently by sending a corresponding command to a command port COM of the terminal T, which is a mobile telephone, for example, of the GSM or other type, as shown in the FIGURE. Of course, other modes of presenting information so that the user can see it or hear it could equally be provided.

The terminal T further includes means SD for entry of data by the user, in the case of a telephone taking the form of a keypad SC thereof and a microphone SM used for telephone dialogue.

The terminal T also includes one or more sensors C of one or more particular characteristics of the user's environment. For example, a first sensor CL measures the ambient light level L (meaning the brightness of the light impinging on the terminal T, not that emitted by its screen E). For example, a second sensor CS measures the ambient sound level S using the microphone SM or a separate microphone. For example, a third sensor CM senses whether the terminal T is moving (M) or stopped relative to its environment or measures the speed of movement of the terminal T relative to the environment. This third sensor may equally sense the presence of the user, like those used for remote surveillance, or an obstacle, like those used in the automotive sector. The characteristics measured by the sensors C are scanned continuously and stored in a memory space of the terminal T, for example.

The environmental characteristic measurement MES (MES=L, S and M in the above situation) produced by the sensor(s) CL, CS, CM is sent to a remote processing platform P in a first message M1. The presentation mode that is currently active on the terminal T is also sensed by any appropriate means, for example the presentation mode control means, to produce an indication IDMA of which of the information presentation modes available on the terminal T is currently active, the indication IDMA being also sent to the platform P in the message M1. The message M1 is sent to the platform P by sending means, for example, using the send/receive antenna ANT of the terminal T, for example, if the terminal is a mobile telephone.

In addition to means F for supplying information INF to be presented to the user of the terminal T in response to a service request sent by the terminal, the platform P includes means R for receiving the message M1 and means A for analyzing the received message. The analysis means A store one or more rules for processing the environment characteristic measurement MES and the indication IDMA of the currently active information presentation mode associated therewith in the received message. For example, one or more processing rules are provided for each information presentation mode.

The analysis in accordance with a processing rule is effected in the following manner.

A first step determines if the currently active information presentation mode indication IDMA included in the received message M1 is equal to a prescribed information presentation mode indication IDMR for this rule.

If so, in other words if IDMA=IDMR, the environmental characteristic measurement MES present in the received message M1 is analyzed to determine if it conforms to one or more prescribed conditions for that rule.

If the analysis means A determine that the measurement MES conforms to the condition prescribed by the rule, they supply a positive rule verification signal and automatically trigger the generation by means GA of an instruction IA to activate an information presentation mode prescribed in the rule and not the active mode corresponding to the indication IDMA and the sending of the activation instruction IA to the terminal T by appropriate sending means E. The terminal T includes means RIA for receiving activation instructions IA and the information INF produced by the platform P and sent by its sender means E. If the terminal T is a mobile telephone, for example, the receiver means RIA use its send/receive antenna ANT.

The platform P and the terminal T communicate, in particular for sending service requests, information INF, data, messages M1 and instructions IA, via any of the following network types: 802.11, Bluetooth, Wi-Fi, RTC, GSM Data, UMTS.

When the receiver means RIA of the terminal T receives an activation instruction IA, they command the activation of the presentation mode specified in the received instruction IA via the command port COM of the information presentation means PINF of the terminal T, so that the information is presented to the user at least in accordance with the prescribed information presentation mode, which is not the same as the previous one and may be added to or substituted for the previous one, the latter option being more economic in terms of the power consumption of the terminal T. The processing rule does not modify the mode of presentation of information on the terminal T if it is found not to apply to the message M1.

There are given above examples of processing rules and of changing or adding presentation modes to the terminal T in the case of application of those rules.

A first processing rule of the processing platform applies to the situation in which the presentation mode that is currently active on the terminal T is a graphic mode, i.e. to the situation where IDMA=IDMR=G. The corresponding condition C1 of this first rule relates to the measured ambient light level L: if the measured ambient light level L is less than or equal to a prescribed ambient light value LP, then the prescribed new information presentation mode triggered by the activation instruction IA corresponds to the vocal mode V on the terminal T. This first rule therefore switches the terminal T to vocal presentation V of the information to the user as well as or instead of the graphic mode G, to enable the user to hear the information in darkness or in an ill-lit environment, which corresponds to a light level L less than or equal to the prescribed value LP.

A second processing rule of the processing platform applies to the situation in which the presentation mode that is currently active on the terminal T is a vocal mode, i.e. to the situation where IDMA=IDMR=V. The corresponding condition C2 of this second rule relates to the measured sound level S: if the measured ambient sound level S is greater than a prescribed ambient sound level value SP, then the prescribed new information presentation mode triggered by the activation instruction IA corresponds to the graphic presentation mode G on the terminal T. This second rule therefore switches the terminal T to the graphic mode G of presenting the information to the user as well as or instead of the vocal mode V, to enable the user to see the information in a noisy environment, which corresponds to a sound level S greater than the prescribed value LP.

A third processing rule of the processing platform applies to the situation in which the presentation mode that is currently active on the terminal T is a graphic mode, i.e. to the situation where IDMA=IDMR=G. The corresponding condition C3 of this third rule relates to the motion measurement M from the third sensor CM: if the measured value of the motion level M is greater than a prescribed motion level value MP, then the prescribed new information presentation mode triggered by the activation instruction IA corresponds to the vocal mode V on the terminal T. This third rule therefore switches the terminal T to the vocal mode V of presenting information to the user as well as or instead of the graphic mode G, to enable the user to hear the information, while moving with the terminal T, which corresponds to M>MP, for example walking or running with it and therefore not always able to look closely at the terminal, because of the relative movement between the terminal and the eyes.

A fourth processing rule of the processing platform applies to the situation in which the presentation mode that is currently active on the terminal T is a graphic mode, i.e. to the situation where IDMA=IDMR=G. The corresponding condition C4 of this fourth rule relates to the motion measurement M from the third sensor CM and to the measured ambient sound level S: if the measured value of the motion level M is greater than the prescribed motion level value MP and if the measured value of the ambient sound level S is less than or equal to another prescribed ambient sound level value SP2, then the prescribed new information presentation mode triggered by the activation instruction IA corresponds to the vocal mode V on the terminal T. This fourth rule therefore switches the terminal T to the vocal mode V for presenting information to the user, as well as or instead of the graphic mode G, to enable the user to hear the information, while moving with the terminal T, which corresponds to M>MP, for example walking or running with it and therefore not always able to look closely at the terminal, because of the relative movement between the terminal and the eyes, and when the surrounding environment is not too noisy for the information to be heard, which corresponds to S≦SP2.

A fifth processing rule of the processing platform applies to the situation in which the presentation mode that is currently active on the terminal T is a vocal mode, i.e. to the situation where IDMA=IDMR=V. The corresponding condition C5 of this fifth rule relates to the motion measurement M from the third sensor CM and to the ambient sound level measurement S: if the measured value of the motion level M is greater than a prescribed motion level value MP and if the measured value of the ambient sound level S is greater than the other prescribed ambient sound level value SP2, then the prescribed new information presentation mode triggered by the activation instruction IA corresponds to the graphic mode G on the terminal T. This fifth rule therefore switches the terminal T to graphic display G of information to the user as well as or instead of the vocal mode V, to enable the user to see the information, while moving with the terminal T, which corresponds to M>MP, for example walking or running with it, and when the user's environment is too noisy for the information to be heard, which corresponds to S>SP2, in which case the user must look closely at the terminal, despite the relative movement between the terminal and the eyes.

The measurement L is expressed in lux, for example, as is the parameter LP. The measurement S is expressed in decibels, for example, as are the parameters SP and SP2. The measurement M is expressed in meters per second, for example, as is the parameter MP.

One or more of the first to fifth processing rules described above may be present in the platform P. One or more of the processing rules may be associated with an identified terminal T, or not, at the choice of its user, via a communication interface appropriate for the user between the terminal T and the platform P, the association(s) of one or more rules with an identifier of the user being stored in a user profile memory MEM of the platform P. One or more of the processing rules may be associated by default with all the terminals T. Similarly, not only can the user use the terminal T and its communications interface to modify the parameters LP, SP, MP, SP2 of the rules described above, but the user can also create other processing rules, specifying the mode IDMR to which it applies, the measurement(s) MES to which it applies, the criterion (greater than, less than or equal to) used for that measurement MES, the prescribed comparison threshold value of that measurement (the parameters LP, SP, MP, SP2 in the rules described above), the prescribed new presentation mode specified in the activation instruction IA, and whether it is to be added to or to replace the preceding presentation mode on the terminal T. This communication interface uses the Internet, for example, or a mobile telephone Internet (WAP) service. Processing rules may be modified or created from the terminal T or from any other machine of the user.

The measurement MES is executed and the message M1 is sent each time that the user of the terminal T actuates a control on the terminal, for example, such as data entry means SD thereof, the terminal T including for this purpose actuation detection means DA. Thus the measurement MES is executed and the message M1 is sent each time the terminal T sends a service request to the platform P, for example. If the graphic mode G is active on the terminal T, for example, the message M is appended to the service request, which may be of the http type, for example in the header of the http request. If the vocal mode V is active on the terminal T, for example, the message M is coded digitally by the voice coder of the terminal and is sent in the form of additional data packets, to be decoded by the corresponding voice decoder on the platform P. For example, the measurement MES is sent specifying the measured parameter type (L, S or M in the above example) and its last numerical value as measured by the corresponding sensor.

In order for the service and the supply of information to the terminal T not to be interrupted, in one embodiment the platform P includes one or more memories MINF for saving data entered on the terminal via the entry means SD in an internal data structure, for example, when the current presentation of information relates to browsing the Internet, managing an indicator IPS of the phase of the service in progress and an indicator IE of the current browsing step in that phase. After execution of the activation instruction IA on the terminal T, the saved data reverts to that from the memory MINF, the service proceeding as far as the current phase indicated by IPS and the current step indicated by IE. The call in progress and the service consultation context are therefore preserved.

1. A method of controlling a terminal (T) having a plurality of modes (G, V) of presenting information to a user that can be activated or deactivated on the terminal (T) and perceived by a respective plurality of different senses of the user, characterized in that
a sensor (CL, CS, CM) in the terminal (T) measures an environmental characteristic (L, S, M) thereof;
a message (M1) is sent to a remote processing platform (P) containing the measured environmental characteristic (MES, L, S, M) and an indication (IDMA) of the information presentation mode currently active on the terminal (T), that is one of the indications of the presentation modes (G, V) available therein;
the indication (IDMA) present in the message (M1) of the information presentation mode that is currently active is analyzed in accordance with a prescribed processing rule in the processing platform (P) to determine if it corresponds to a presentation mode indication (IDMR) that is one of the indications of the presentation modes available on the terminal and is prescribed by that processing rule, and
if so, the measured value of the environmental characteristic (MES, L, S, M) is analyzed to determine if it conforms to a prescribed condition (C1, C2, C3, C4, C5) of said processing rule in order, if so:
to trigger automatically sending from the processing platform (P) to the terminal (T) of an instruction (IA) for activating therein a mode of presentation of information to the user selected from those available, prescribed in said processing rule, and other than the currently active information presentation mode corresponding to the indication (IDMA) present in the message (M1);
reception in the terminal (T) of the activation instruction (IA) causing the activation therein of said other prescribed information presentation mode specified in the activation instruction (IA).

2. A control method according to claim 1, characterized in that, in accordance with a first processing rule of the processing platform (P), the prescribed presentation mode indication (IDMR) corresponds to one of the graphic presentation modes (G) available on the terminal (T), which includes an environmental characteristic sensor in the form of an ambient light level sensor (CL), the prescribed condition (C1) corresponds to the fact that the measured value of the ambient light level (L) is less than a prescribed ambient light value (LP), and said other prescribed information presentation mode specified in the activation instruction (IA) corresponds to one of the vocal presentation modes (V) available on the terminal (T).

3. A control method according to claim 1, characterized in that, in accordance with a second processing rule of the processing platform (P), the prescribed presentation mode indication (IDMR) corresponds to one of the vocal presentation modes (V) available on the terminal (T), which includes an environmental characteristic sensor in the form of an ambient sound level sensor (CS), the prescribed condition (C2) corresponds to the fact that the measured value of the ambient sound level (S) is greater than a prescribed ambient sound level value (SP), and said other prescribed information presentation mode specified in the activation instruction corresponds to one of the graphic presentation modes (G) available on the terminal (T).

4. A control method according to claim 1, characterized in that, in accordance with a third processing rule of the processing platform (P), the prescribed presentation mode indication (IDMR) corresponds to one of the graphic presentation modes (G) available on the terminal (T), which includes an environmental characteristic sensor in the form of a sensor (CM) of motion or of stopping of motion of the terminal (T) relative to its environment, the prescribed condition (C3) corresponds to the fact that the measured value of the motion level (M) is greater than a prescribed motion level value (MP), and said other prescribed information presentation mode specified in the activation instruction (IA) corresponds to one of the vocal presentation modes (V) available on the terminal (T).

5. A control method according to claim 1, characterized in that, in accordance with a fourth processing rule of the processing platform (P), the prescribed presentation mode indication (IDMR) corresponds to one of the graphic presentation modes (G) available on the terminal (T), which includes environmental characteristic sensors in the form of a sensor (CM) of motion or of stopping of motion of the terminal (T) relative to the environment and an ambient sound level sensor (CS), the prescribed condition (C4) corresponds to the fact that the measured value of the motion level (M) is greater than a prescribed motion level value (MP) and the fact that the measured value of the ambient sound level (s) is less than a prescribed ambient sound level value, and said other prescribed information presentation mode specified in the activation instruction corresponds to one of the vocal presentation modes (V) available on the terminal (T).

6. A control method according to claim 1, characterized in that, in accordance with a fifth processing rule of the processing platform (P), the prescribed presentation mode indication (IDMR) corresponds to one of the vocal presentation modes (V) available on the terminal (T), which includes environmental characteristic sensors in the form of a sensor (CM) of motion or of stopping of motion of the terminal (T) relative to the environment and an ambient sound level sensor (CS), the prescribed condition (C5) corresponds to the fact that the measured value of the motion level (M) is greater than a prescribed motion level value (MP) and the fact that the measured value of the ambient sound level (S) is greater than a prescribed ambient sound level value (SP2), and said other prescribed information presentation mode specified in the activation instruction corresponds to one of the graphic presentation modes (G) available on the terminal (T).

7. A control method according to claim 1, characterized in that each time actuation of a control of the terminal (T) by the user is detected in the terminal (T) an environmental characteristic (MES, L, S, M) thereof is a measured in said terminal (T), followed by sending the processing platform (P) said message (M1) including the measured environmental characteristic (MES, L, S, M) and the indication (IDMA) of the information presentation mode currently active on the terminal (T).

8. A control method according to claim 7, characterized in that said message (M1) including the measured environmental characteristic (MES) and an indication (IDMA) of the information presentation mode currently active on the terminal (T) is sent to the platform (P) with a request for information, the platform (P) being adapted to send the information (INF) to the terminal (T).

9. A control method according to claim 1, characterized in the terminal (T) includes means (SD) for entry of data by the user, the processing platform (P) includes a memory (MINF) for storing data entered on the terminal (T), and, after activation on the terminal (T) of said other prescribed information presentation mode specified in the activation instruction (IA), the data of the terminal (T) reverts to that stored before said activation.

10. A processing platform for implementing a control method according to claim 1, characterized in that the processing platform includes:
means (R) for receiving a message (M1) including said measured environmental characteristic (MES, L, S, M) and said indication (IDMA) of the information presentation mode currently active on the terminal (T) that is one of the indications of the presentation modes (G, V) available thereon;
means (A) for analyzing in the processing platform (P) and in accordance with a prescribed processing rule the indication (IDMA) of the information presentation mode that is currently active present in the message (M1) to determine if it corresponds to a presentation mode indication (IDMR) prescribed by that processing rule that is one of the indications (G, V) of the presentation modes available on the terminal (T), and, in so, to determine if the measured value of the environmental characteristic (MES, L, S, M) present in the message (M1) conforms to a prescribed condition (C1, C2, C3, C4, C5) of said processing rule to supply a positive signal in the event of an affirmative response; and
means (GA, E) for automatically sending from the processing platform (P) to the terminal (T), if the analysis means (A) supply a positive signal, an instruction (IA) for activation thereon of a prescribed mode of presentation of information to the user that is one of those available and is not the information presentation mode that is currently active corresponding to the indication (IDMA) present in the message (M1).

11. A processing platform according to claim 10, characterized in that the processing platform comprises means (F) for supplying information (INF) and means (E) for sending the information to the terminal (T).

12. A terminal for implementing the control method according to claim 1 having a plurality of modes (G, V) of presenting information to the user which can be activated or deactivated on the terminal (T) and are perceived by a respective plurality of different senses of the user, characterized in that the terminal includes:
a sensor (CL, CS, CM) for measuring an environmental characteristic (L, S, M) of the terminal (T);
means for sending to the remote processing platform (P) a message (M1) including the measured environmental characteristic (MES, L, S, M) and an indication (IDMA) of the information presentation mode that is currently active on the terminal (T) and is one of the indications of the presentation modes (G, V) available thereon; and
means (RIA) for receiving an activation instruction (IA) causing activation in the terminal (T) of an information presentation mode that is specified in the activation instruction (IA) that is one of those available on the terminal (T).

13. A terminal according to claim 12, characterized in that the terminal (T) includes one or more of the following environmental characteristic sensor: an ambient light level sensor (CL), an ambient sound level sensor (CS), a sensor (CM) of motion or of stopping of motion of the terminal (T) relative to the environment, a sensor of the presence of persons, an obstacle sensor.
